(19) United States
(12) Patent Application Publication
(10) Pub. No.: US 2022/0114806 A1
(43) Pub. Date: Apr. 14, 2022

(54) AUTOMATED CAPTURING OF IMAGES COMPRISING A DESIRED FEATURE

(71) Applicant: MOBIUS LABS GMBH, Berlin (DE)

(72) Inventors: Hicham BADRI, Berlin (DE); Aleksandr MOVCHAN, Berlin (DE); Appu SHAJI, Berlin (DE)

(21) Appl. No.: 17/421,084

(22) PCT Filed: Dec. 23, 2019
(86) PCT No.: PCT/EP2019/086967

§ 371 Date: Jul. 7, 2021

(30) Foreign Application Priority Data
Jan. 7, 2019 (EP) 19150572.6

(51) Int. Cl. G06V 10/778; G06V 10/774; G06V 10/24; G06V 20/17

(52) U.S. Cl. CPC G06V 10/7788; G06V 20/17; G06V 10/245; G06V 10/7747

(57) ABSTRACT

The present invention relates to a method, system and software for automatically capturing a target image in a movable device. The method comprises at least one of the steps of providing at least one image feature for the target image to be captured; monitoring image data; and capturing at least one target image when the image data monitored fulfill the image feature.

### FIELD

The present invention generally relates to the field of videography and photography using movable devices, for example portable devices such as smartphones and tablets. More specifically, the present invention relates to automated capturing of photographic and/or video images comprising a desired feature.

### BACKGROUND

Generally, existing algorithms for image pattern recognition, that is algorithms that can identify a certain feature within an image, require a lot of resources. In particular the training of machine-learned image pattern recognition algorithms requires high processing power. Images are often composed of more than one million pixels and training an image pattern recognition algorithm may require about one thousand images per feature that should be identified. Therefore, such systems are often run on powerful computers and with the help of graphic processor units (GPUs).

Running such an application on a movable device may be particularly challenging. In particular if the aim is to identify a feature through an image sensor and subsequently capture a photographic and/or video image comprising the feature, while the movable device, that is the image sensor, may be moved in search for a fitting feature.

In most instances a typical user of a movable device not only wishes to take a picture that is comprising a particular feature, but also that the picture may provide an aesthetically pleasing composition. According to the state of the art such features are only checked in post-processing of images, that is once the images have been taken.

Further, the individual perception of image composition and potentially a feature may vary between different users. Therefore, it may be desirable to train the system to the individual perception of a specific user. That is, to improve and individualize results based on the judgement of the user.

For example, U.S. Pat. No. 9,412,043 B2 discloses a system, method, and computer program product for assigning an aesthetic score to an image. A method disclosed therein includes receiving an image comprising a set of global features. The method includes extracting a set of global features for the image. The method further includes encoding the extracted set of global features into a high-dimensional feature vector. The method further includes reducing the dimension of the high-dimensional feature vector. The method further includes applying a machine-learned model to assign an aesthetic score to the image, wherein a more aesthetically-pleasing image is given a higher aesthetic score and a less aesthetically-pleasing image is given a lower aesthetic score.

### SUMMARY

In light of the above, it is an object to overcome or at least alleviate the shortcomings and disadvantages of the prior art. That is, it is an object of the present invention to provide a system to automatically capture photographic and/or video images comprising a desired feature.

These objects are met by the present invention.

The present invention relates to a method, system and software for automatically capturing a target image in a movable device. It will be primarily described by means of the method steps. The corresponding device features correspond to the method steps wherever possible.

The term movable is used for systems and devices that are particularly configured to be moved although they can also be used in static form. Examples can be portable or handheld devices or devices that move actively or passively.

The method according to the present invention particularly comprises at least one of the steps of providing at least one image feature for the target image to be captured; monitoring image data; and capturing at least one target image when the image data monitored fulfill the image feature.

The image data can be generated by an optical system that can be further affiliated to the movable device or system. The image data can comprise image data relating to a sequence of images.

The monitoring can be performed by a processing component, such as a CPU or GPU affiliated to the system or device.

The target image is intended to mean the image or photo or video that fulfills the pre-set expectations of the user. It can also be randomly generated in case the user wants to allow the device to select and surprise him or her. In any case the images on the image sensor are detected and a capturing or the shutter can be activated once the image data and/or the image on the monitor fulfill the image feature. It is also within the meaning to allow the device to add image information or data in order to generate an image that is composed of a number of parts to be composed to an image. Furthermore, the quality of the image displayed and/or the target image can be increased.

According to the invention the monitoring of the image data can comprise a controlling by a controlling library that is preferably provided by the movable device or system as well. The controlling library and the feature library can be unified to one library component to be implemented into the device. As outlined later the image feature can be rather generic, such as “romantic”, “dynamic”, “convertible into black and white” and/or rather specific as a face of a known person, a pre-specified animal or a part thereof, such as “face of Jim” or “whole person of Barbara” or “dog running”. Any aggregation of image features can also be selected such as “romantic” and “whole person of Barbara”.

The image feature can be static so that the same name for it always addressed the same and unamended feature. A further progression or evolution of that feature could then be called with an indication added to the name of the original feature, such as “romantic01”. Alternatively, the AI approach allows to also change the feature and adapt it more and more to the expectations of a user. For that the user could be provided with a selection of recent images and the user is then being asked to pick the images that suit the user's expectations best. Also or alternatively a choice of elimination approach can be used in order to eliminate alternatives that don't fit the expectations of the user.

The present invention is particularly adapted to components affiliated to a handheld device, such as a smartphone or tablet. The preferred advantage is that the user can just hold and slightly or quickly move the handheld device and the image, such as a photo, a video or a mixture thereof, is captured without the need of the user to press the shutter for activation. It can be understood that this is useful for over the head photography, selfies, panoramas with the device deciding when is the most suitable time to activate the shutter. Additionally, an image optimizer can simultaneously or with a delay optimize the photo that the user would not have chosen without knowing the chances for or the result of optimization(s).

The image data can be reduced in at least one of resolution and quality during its monitoring. Then the reduced image data can be improved in at least one of quality and resolution and displayed on a monitor, preferably a monitor affiliated to the device. The ratio of at least one of the resolution and quality of the image data monitored and the one displayed can be at least 1:2, preferably at least 1:3 and more preferably at least 1:5.

The image feature can be provided by a feature library. The library can be completely located on the movable device or a remote storage, such as a server or the cloud, and/or the library can be stored in part on the device and the server. Particularly advantageous is to store and activate the image features on the movable device. Those preferred image features to be stored locally can also be automatically selected by the present invention and ranked accordingly. The first part of selected image features can then be stored on the movable and renewed accordingly.

The present invention also comprises the uploading of the image feature from a feature library into a cache or RAM storage of the movable device before the monitoring of the images. This increases the speed of computing and reactivity of the movable device.

Additionally or alternatively, a step of caching the images or a video section monitored can be provide with the a retroactively storing of the image, such as a photo and/or a video, when the image fulfil the image feature. This can a allow a more precise computing or selecting of appropriate images.

A further step of or device component for displaying a plurality of image features on a menu on a screen can be provided as well with an uploading of the image feature from a storage into a cache or RAM storage upon their selection before the monitoring of the images.

A step of or device component for uploading at most 20 image features into the cache or RAM can be provided as well in order to limit the cache or RAM capacity needed in the movable device. Preferably at most 10 image features can be uploaded and more preferably at most 5. Those steps and features of the present invention allows the increase of reactivity of the movable device despite the computer power and/or storage that is generally limited in those devices.

The feature library can be stored in a storage/memory provided on at least one of the movable device and remote device, such as on a server. This embraces an additional storage of images on both entities or to store older images on the remote device and more recent images on the movable device.

Additionally or alternatively a step of or device component generating or optimizing the image feature can be provided by an image pattern recognition algorithm analyzing selected images representative for the image feature.

A step of or device component for generating or optimizing the image feature can be provided by an image pattern recognition algorithm analyzing selected images on a remote computing system, such as a remote server or the cloud and feeding the image features generated or optimized to the movable device for use within the device.

A step of or device component for selecting the selected images representative for the image feature from a choice of images by at least one of a user and an image selection algorithm can be arranged as well.

The present invention can also comprise the step of or component for providing the choice of images by at least one of a storage on the movable device and a remote device, such as a server or the cloud. The images monitored can be generated by moving at least the image sensor. A lens or lens system in front of the image sensor with optionally other components can be provided as well.

Moreover, a step of or component for moving with a moving speed of between 0.1 m/s to 50 m/s, preferably between 0.1 m/s to 30 m/s, more preferably between 0.1 m/s to 20 m/s can be provided.

Additionally or alternatively, a step of or component for moving by at least one of a user and a user-controlled drive and an automated drive can be provided. A step of or component for moving the system at least one of land borne, waterborne, airborne and in space can be provided as well.

The drive can be at least one of a semi-autonomous drive and autonomous drive, such as a drone or a robot. In case of a driving waterborne the device can be provided for a swimming and/or submarine purpose. An airborne robot or drone can be a glider, a balloon, propelled or jet driven.

The drive can also be a satellite.

The movable device can be a moving device. That is, the device, such as the robot, the drone or the satellite, can be moving while other method steps are performed.

A step of or component for stabilizing the target image when it is captured can be provided as well.

The images monitored can be displayed in real time on a screen, streamed or cached upon needs as well.

The image sensor can comprise a resolution of at least 2 megapixel, preferably at least 4 megapixel and more preferably 8 or even 12 megapixel.

Further steps of or component for activating a shutter of the movable device when the images monitored fulfill the image feature for the target image; and storing the target image on the movable device can be provided.

A plurality of target images can be stored that constitute a video sequence. The target image captured can be stored on a remote storage, such as a server storage.

The machine learning algorithm can be trained to recognize visually pleasing images. The machine learning algorithm can be trained on the device by the end user to recognize visually pleasing images according to individual personal taste. Moreover, it can be trained on the device by the end user to recognize visually pleasing images according to guidelines set by an individual or a company. The machine learning algorithm can be also trained on the device by the end user to recognize visually relevant images that match a previously not trained object, person(s), location, event or emotion(s). Moreover, it can be trained to recognize a subsection of an image that the algorithm deems to be more visually pleasing. The machine learning algorithm can be trained to recognize geological phenomena, such as interesting topographies, weather patterns or natural disasters. The machine learning algorithm can also be trained to recognize human activities, such as suspicious human behavior.

It can also be adapted to recognize a subsection of an image that highlights a visually relevant object, person(s), location, event, the geological phenomena, the human activities or emotions or estimate an image transformation that enhances at least one of the colors, tonality and texture of the image to make the resulting image more aesthetically pleasing.

It can further estimate an image transformation that enhances at least one of the colors, tonality and texture of the image to make the resulting image more aesthetically pleasing For this task it may be trained on at least one of pairs of images/videos that have been post processed by expert human image/video editors before and/or two independent sets of images/videos; a set of unprocessed images/videos and a second set of images/videos that have been manually post processed by an expert human image/video editor. Additionally or alternatively, it can estimate an image transformation that enhances the colors, tonality and texture of the image to make the resulting image more aesthetically pleasing wherein the machine learning algorithm is trained to recognize visually pleasing images.

The machine learning algorithm(s) can also comprise at least one neural network with at least 1 layer or a deep neural network with a plurality of layers.

The present invention also embraces a computer related product comprising a software for performing the method according to any of the preceding methods or below specified method embodiments.

The invention also concerns a computer program product comprising instructions, which, when the program is executed by the device or system as described and specified, cause the device to perform any of the preceding method embodiments. The present invention also embraces the use of the described systems or methods, particularly according to any of the following method or system embodiments in a handheld, such as a smartphone or tablet and/or use in a land borne, waterborne or airborne drone or robot.

### EMBODIMENTS

Below, reference will be made to method embodiments. These embodiments are abbreviated by the letter “M” followed by a number. Whenever reference is herein made to “method embodiments”, these embodiments are meant.

M1. Method of automatically capturing a target image in a movable device (100) comprising the steps of:
a. providing at least one image feature for the target image to be captured;
b. monitoring image data;
c. capturing at least one target image when the image data monitored fulfills the image feature.

M2. Method according to the preceding method embodiment wherein the monitoring of the image data is performed by a processing component (110) of the device, such as a GPU or CPU.

M3. Method according to any of the preceding method embodiments wherein the movable device (100) is a portable or handheld device, such as a smartphone or tablet.

M4. Method according to any of the preceding method embodiments wherein the target image is a photographic image or video image.

M5. Method according to any of the preceding method embodiments wherein the image feature is provided by a feature library.

M6. Method according to the preceding method embodiment wherein the feature library is provided by the movable device.

M7. Method according to any of the preceding method embodiments wherein the monitoring of the image data comprises a controlling by a controlling library.

M8. Method according to the preceding method embodiment wherein the controlling library is provided by the movable device.

M9. Method according to any of the 4 preceding method embodiments wherein the controlling library and the feature library are unified to one library component to be implemented into the device.

M10. Method according to any of the preceding method claims with the further step of uploading the image feature from a feature library into a cache or RAM storage of the movable device (100) before the monitoring of the images.

M11. Method according to any of the preceding method claims with the further step of displaying a plurality of image features on a menu on a screen and uploading the image feature from a storage into a cache or RAM storage upon their selection before the monitoring of the images.

M12. Method according to the preceding method embodiment with the step of uploading more than one image feature and merging the image features into one image feature for monitoring the image data.

M13. Method according to the preceding method embodiments with the step of caching the images or a video section monitored and retroactively storing the image, such as a photo and/or a video, when the image fulfils the image feature.

M14. Method according to any of the preceding method embodiments with the step of generating or optimizing the image feature by an image pattern recognition algorithm analyzing selected images representative for the image feature on the device (100).

M15. Method according to the preceding method embodiment with the step of generating or optimizing the image feature by an image pattern recognition algorithm analyzing selected images on a remote computing system (210), such as a remote server or the cloud and feeding the image features generated or optimized to the movable device (100) for use within the device.

M16. Method according to the preceding method embodiment with the step of at least one of selecting the selected images representative for the image feature from a choice of images and an elimination of images by at least one of a user and an image selection algorithm.

M17. Method according to the preceding method embodiment with the step of providing the choice of images by at least one of a storage on the movable device (100) and a remote device (210), such as a server or the cloud.

M18. Method according to any of the preceding method embodiments wherein the images monitored are generated by moving at least a source for collecting the image data.

M19. Method according to the preceding method embodiment with the step of moving with a moving speed of between 0.05 m/s to 50 m/s, preferably between 0.1 m/s to 30 m/s and more preferably between 0.1 m/s to 20 m/s.

M20. Method according to any of the two preceding method embodiments with the step of moving the device by at least one of a user and a user-controlled drive and an automated drive.

M21. Method according to the preceding method embodiment with the step of moving at least one of land borne, waterborne, airborne and in space.

M22. Method according to any of the two preceding method embodiments wherein the device or the drive is at least one of a semi-autonomous drive and autonomous drive, such as a drone or a robot.

M23. Method according to any of the preceding method embodiments, wherein the movable device (100) is a moving device.

M24. Method according to any of the preceding method embodiments further comprising the step of stabilizing the target image when it is captured.

M25. Method according to any of the preceding method embodiments wherein the image data is reduced in at least one of resolution and quality during its monitoring.

M26. Method according to the preceding method embodiment wherein the reduced image data is improved in at least one of quality and resolution and displayed on a monitor, preferably a monitor affiliated to the device.

M27. Method according to the two preceding method embodiments wherein the ratio of at least one of the resolution and quality of the image data monitored and the one displayed is at least 1:2, preferably at least 1:3 and more preferably at least 1:5.

M28. Method according to any of the preceding method embodiments wherein the images monitored are displayed in real time on a screen.

M29. Method according to any of the preceding method embodiments wherein the target image comprises a resolution of at least 2 megapixel, preferably at least 4 megapixel and more preferably 8 megapixel, and even more preferably 12 megapixel.

M30. Method according to the preceding method embodiment with the further steps of
d. activating the capture and storage of image(s) by the movable device (100) when the images monitored fulfill the image feature for the target image; and
e. storing the target image on the movable device (100).

M31. Method according to any of the preceding method embodiment with the step of selecting a plurality of related target images and displaying them for the choice by the user.

M32. Method according to the preceding method embodiment with the step of displaying 2-5 target images and preferably 3 target images.

M33. Method according to the preceding method embodiment wherein a plurality of target images is stored that constitutes a video sequence.

M34. Method according to any of the preceding method embodiments wherein the target image captured is stored on a remote storage, such as a server storage.

M35. Method according to any of the preceding method embodiments wherein the image pattern recognition algorithm comprises a machine learning algorithm.

M36. Method according to the preceding method embodiment wherein the machine learning algorithm is trained to recognize a plurality of different objects, such as people, locations, events and emotions.

M37. Method according to any of the two preceding method embodiments, wherein the machine learning algorithm is trained to recognize geological phenomena, such as interesting topographies, weather patterns or natural disaster.

M38. Method according to any of the three preceding method embodiments, wherein the machine learning algorithm is trained to recognize human activities, such as suspicious human behavior.

M39. Method according to any of the four preceding method embodiments wherein the machine learning algorithm is trained to recognize visually pleasing images.

M40. Method according to the preceding embodiment wherein the machine learning algorithm is trained on the device by the end user to recognize visually pleasing images according to individual personal taste.

M41. Method according to the penultimate embodiment wherein the machine learning algorithm is trained on the movable device (100) by the end user to recognize visually pleasing images according to guidelines set by an individual or a company.

M42. Method according to any of the preceding method embodiments and including the features of method embodiment M34, wherein the machine learning algorithm is trained on the movable device (100) by the end user to recognize visually relevant images that match a previously not trained object, person(s), location, event or emotion(s).

M43. Method according to any of the preceding method embodiments and including the features of method M36, wherein the machine learning algorithm is trained to recognize a subsection of an image that the algorithm deems to be more visually pleasing.

M44. Method according to any of the preceding method embodiments and including the features of method embodiment M34, wherein the machine learning algorithm is trained to recognize a subsection of an image that highlights a visually relevant object, person(s), location, event or emotions.

M45. Method according to any of the preceding method embodiments wherein the image pattern recognition algorithm comprises a machine learning algorithm to estimate an image transformation that enhances at least one of the colors, tonality and texture of the image to make the resulting image more aesthetically pleasing.

M46. Method according to the preceding method embodiment wherein the machine learning algorithm to estimate an image transform that enhances at least one of the colors, tonality and texture of the image to make the resulting image more aesthetically pleasing is trained on pairs of images/videos that have been post processed by expert human image/video editors before.

M47. Method according to any of the two preceding method embodiments wherein the machine learning algorithm is provided to estimate an image transformation that enhances at least one of the colors, tonality and texture of the image to make the resulting image more aesthetically pleasing is trained by two independent sets of images/videos; a set of unprocessed images/videos and a second set of images/videos that have been manually post processed by an expert human image/video editor.

M48. Method according to any of the three preceding method embodiments, wherein the machine learning algorithm is provided to estimate an image transformation that enhances the colors, tonality and texture of the image to make the resulting image more aesthetically pleasing wherein the machine learning algorithm is trained to recognize visually pleasing images.

M49. Method according to any of the preceding method embodiments wherein the machine learning algorithm(s) comprise at least one neural network with at least 1 layer or a deep neural network with a plurality of layers

M50. Computer related product comprising a software or library for performing the method according to any of the preceding method embodiments.

M51. A computer program product comprising instructions, which, when the program is executed by a device (100), cause the device to perform any of the preceding method embodiments.

Below, reference will be made to system embodiments. These embodiments are abbreviated by the letter “S” followed by a number. Whenever reference is herein made to “system embodiments”, these embodiments are meant.

S1. A movable system (100) for automatically capturing a target image that is configured to carry out a method according to any of the preceding method embodiments or that comprises the preceding computer program product.

S2. A movable system (100) for automatically capturing a target image comprising:
a. a storage (130; 210) with at least one image feature for the target image to be captured;
b. a monitoring component (110) for monitoring image data;
c. a capturing component (120, 130) for capturing at least one target image when the image data monitored fulfills the image feature.

S3. System according to any of the preceding system embodiments comprising a processing component (110), such as a GPU or CPU, that is configured to monitor the image data.

S4. System according to any of the preceding system embodiments wherein the system is a portable or handheld device, such as a smartphone or tablet.

S5. System according to any of the preceding system embodiments wherein the system comprises an optical component for generating the image data.

S6. System according to any of the preceding system embodiments wherein the target image is a photographic image or video image.

S7. System according to any of the preceding system embodiments with a feature library for providing the image feature or a plurality of image features.

S8. System according to any of the preceding system embodiments further comprising a feature library.

S9. System according to the preceding system embodiment wherein the feature library is provided by the movable system (100).

S10. System according to any of the preceding system embodiments further comprising a controlling library that is configured to monitor the image data.

S11. System according to the preceding system embodiment wherein the controlling library is provided by the movable system (100).

S12. System according to any of the 4 preceding system embodiments wherein the controlling library and the feature library are unified to one library component to be implemented into the system.

S13. System according to any of the preceding system embodiments with a further component for displaying a plurality of image features on a menu on a screen and uploading the image feature from a storage into a cache or RAM storage upon their selection before the monitoring of the images.

S14. System according to the preceding system embodiment wherein the feature library is stored in a storage provided on at least one of the movable system (100) and remote device (210), such as on a server.

S15. System according to the preceding system embodiments with component for caching the images or a video section monitored and retroactively storing the image, such as a photo and/or a video, when the image fulfils the image feature.

S16. System according to any of the preceding system embodiments with a component for generating or optimizing the image feature by an image pattern recognition algorithm analyzing selected images representative for the image feature.

S17. System according to the preceding system embodiment with a component for generating or optimizing the image feature by an image pattern recognition algorithm analyzing selected images on a remote computing system, such as a remote server or the cloud and feeding the image features generated or optimized to the movable device (100) for use within the device.

S18. System according to the preceding system embodiment with a component for selecting or eliminating the selected images representative for the image feature from a choice of images by at least one of a user and an image selection algorithm.

S19. System according to the preceding system embodiment with a component for providing the choice of images by at least one of a storage on the movable device (100) and a remote device (210), such as a server or the cloud.

S20. System according to any of the preceding system embodiments wherein the images monitored are generated by moving at least the optical component.

S21. System according to the preceding system embodiment with a component for moving with a moving speed of between 0.1 m/s to 50 m/s, preferably between 0.1 m/s to 30 m/s and more preferably between 0.1 m/s to 20 m/s.

S22. System according to any of the preceding two system embodiments with a component for moving by at least one of a user and a user-controlled drive and an automated drive.

S23. System according to the preceding system embodiment with a component for moving which is at least one of land borne, waterborne, airborne and in space.

S24. System according to any of the two preceding embodiments wherein the drive is at least one of a semi-autonomous drive and autonomous drive, such as a drone or a robot.

S25. System according to any of the preceding embodiments further comprising a component for stabilizing the target image when it is captured.

S26. System according to any of the preceding system embodiments wherein the images monitored are displayed in real time on a screen.

S27. System according to any of the preceding system embodiments wherein the image data comprises a resolution of at least 2 megapixel, preferably at least 4 megapixel and more preferably 8 megapixel and more preferably 12 megapixel.

S28. System according to any of the preceding system embodiments wherein the system is configured to reduce the image data in at least one of resolution and quality during its monitoring.

S29. System according to the preceding system embodiment wherein the reduced image data is improved in at least one of quality and resolution and displayed on a monitor, preferably a monitor affiliated to the system.

S30. System according to the 2 preceding system embodiments wherein the ratio of at least one of the resolution and quality of the image data monitored and the one displayed is at least 1:2, preferably at least 1:3 and more preferably at least 1:5.

S31. System according to the preceding system embodiment with further component(s) for
a. activating the shutter of the movable device (100) when the images monitored fulfill the image feature for the target image; and
b. storing the target image on the movable device (100).

S32. System according to the preceding system embodiment wherein a plurality of target images is stored that constitutes a video sequence.

S33. System according to any of the preceding system embodiments wherein the target image captured are stored on a remote device (210), such as a server storage.

S34. System according to any of the preceding system embodiments wherein the image pattern recognition algorithm comprises at least one neural network.

S35. System according to any of the preceding system embodiments describing a functionality of the system, wherein the system is configured to perform the described functionality while the system is moving.

S36. System according to any of the preceding system embodiments, wherein the image pattern recognition algorithm comprises a machine learning algorithm.

S37. System according to the preceding system embodiment, wherein the machine learning algorithm is trained to recognize a plurality of different objects, such as people, locations, events and emotions.

S38. System according to any of the two preceding system embodiments, wherein the machine learning algorithm is trained to recognize visually pleasing images.

S39. System according to any of the three preceding system embodiments, wherein the machine learning algorithm is trained to recognize geological phenomena, such as interesting topographies, weather patterns or natural disaster.

S40. System according to any of the four preceding system embodiments, wherein the machine learning algorithm is trained to recognize human activities, such as suspicious human behavior.

Below, reference will be made to use embodiments. These embodiments are abbreviated by the letter “U” followed by a number. Whenever reference is herein made to “use embodiments”, these embodiments are meant.

U1. Use of the system or method according to any of the preceding method or system embodiments in a handheld, such as a smartphone or tablet.

U2. Use of the system or method according to any of the preceding method or system embodiments or use in a land borne, waterborne or airborne drone or robot.

Embodiments of the present invention will now be described with reference to the accompanying drawings. These embodiments should only exemplify, but not limit, the present invention.

### BRIEF DESCRIPTION OF THE DRAWINGS

FIG. 1 depicts a block diagram of relevant components of a movable device;

FIG. 2 depicts a block diagram of a remote system according to some embodiments of the present invention;

FIG. 3 depicts a flow chart of a method according to some embodiments of the present invention;

FIG. 4 depicts a flow chart illustrating the training of the image pattern recognition algorithm; and

FIG. 5 depicts a handheld device being moved.

### DESCRIPTION OF VARIOUS EMBODIMENTS

It is noted that not all the drawings carry all the reference sings. Instead, in some of the drawings, some of the reference sings have been omitted for the sake of brevity and simplicity of the illustration. Embodiments of the present invention will now be described with reference to the accompanying drawings.

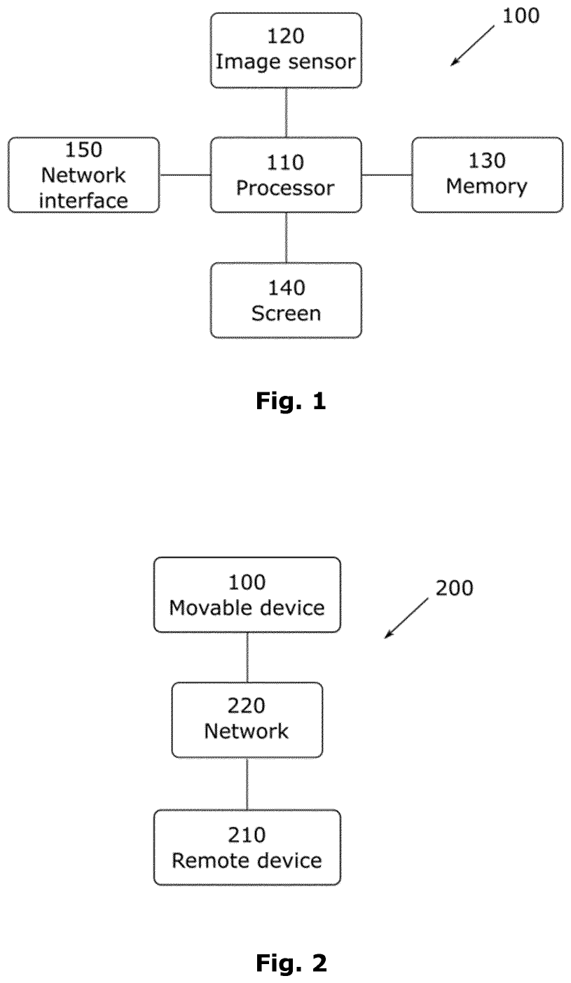

Referring to FIG. 1, a movable device 100 may comprise a processor 110, which may comprise at least one microprocessor, such as central processing unit (CPU) and/or a at least one circuit, such as an application specific integrated circuit (ASIC), field-programmable gate arrays (FPGAs), etc. For example, a movable device 100 may be portable device such as a smartphone or tablet.

Further, the movable device 100 may include at least one memory 130, such as at least one non-volatile storage device (e.g. a solid-state drive (SSD)) and/or at least one volatile storage device (e.g. random-access memory (RAM)). This memory 130 may be configured to save and store the images as well a feature library. Further, machine readable program code may be stored in the memory 130. When executed on the processor 110, the machine-readable code may be configured to cause the processor 110 to execute the tasks and steps described below.

Even further, the movable device 100 may include an image sensor 120, such as an active pixel sensor (APS) or a charge-coupled device (CCD). The image sensor 120 may be used to provide image data which may be stored in the memory 130 in the form of photographic and/or video images.

Image data may also be generated synthetically, for example by means of a graphics processing unit (GPU).

The image sensor 120 may comprise a resolution of at least 2 megapixel, preferably at least 4 megapixel and more preferably 8 megapixel.

Images corresponding to the image data, such as image data from the image sensor 120 or a GPU, may further be displayed in real time on a screen 140. The screen 140 may also be used for user interaction or to show images stored in the memory 130.

In some embodiments, the movable device 100 may further comprise a network interface 150 which may provide means to store the images on a remote storage, such as a sever storage.

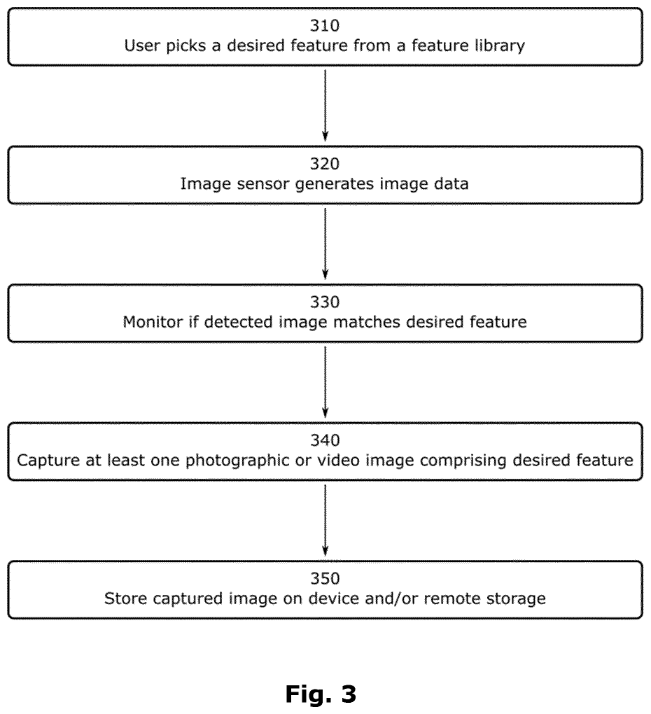

With reference to FIG. 2, the present invention may, in some embodiments, comprise a remote system 200. The movable device 100 may communicate with at least one remote device 210 by means of a network 220, such as the internet. The at least one remote device 210 may be a remote storage, a remote computing system or a combination thereof, such as a server or a cloud system.

In some embodiments, the movable device 100 may retrieve data from and/or store data on a remote device 210 during operation, e.g. images. Further, a remote device 210 may perform resource heavy tasks, that is tasks that for example require high computing power, and feed the resulting data to the movable device 100 by means of the network 220.

FIG. 3 is a flow diagram illustrating steps for a method for automatically capturing at least one photographic or video image comprising at least one desired feature. In an embodiment of the present invention the method comprises the user picking at least one desired feature from a feature library (step 310). That is, during operation the user may choose at least one desired feature, for example by selecting a feature from a selection of options displayed on the screen 140 of the movable device 100.

The feature library may be stored on the movable device 100. Further, the feature library may contain features generated by an image pattern recognition algorithm through analysis of a plurality of representative images for the corresponding image feature.

Image features may include, but not be limited to, certain objects, such as animals, humans, buildings, etc., colours, atmospheres, such as warm, romantic, snowy, sunny, etc., or surroundings, such as landscape, architecture, etc.

In a next step the image sensor 120 starts to generate image data of the surrounding of the movable device 100 which may further be moved by a user-controlled or an automated drive to increase the chance of finding the desired feature (step 320). That is, the movable device 100 may be moved directly by the user or by means of a drive such as a drone or robot. The drive may be controlled directly by the user or it may be a semi-autonomous or autonomous drive. The moving speed may be between 0.05 m/s to 50 m/s, preferably between 0.1 m/s to 30 m/s, more preferably between 0.1m/s to 20 m/s.

Step 320 may also include showing the image corresponding to the image data simultaneously on the screen 140 of the movable device 100. Further, the images may be stabilized when captured.

The processor 110 may monitor the image data detected by the image sensor 120 for the desired feature (step 330). To minimize required computing power, the image data may be reduced in at least one of resolution and quality during monitoring. This may further reduce the resources needed and thus improve performance.

In case of a positive result, i.e. the detected image fulfils the desired feature for the target image, at least one photographic or video image comprising the desired feature is captured (step 340). The captured image may comprise the full resolution provided by the image sensor 120.

Subsequently, the captured image may be stored on the movable device 100 and/or a remote device 210, such as a server storage (step 350).

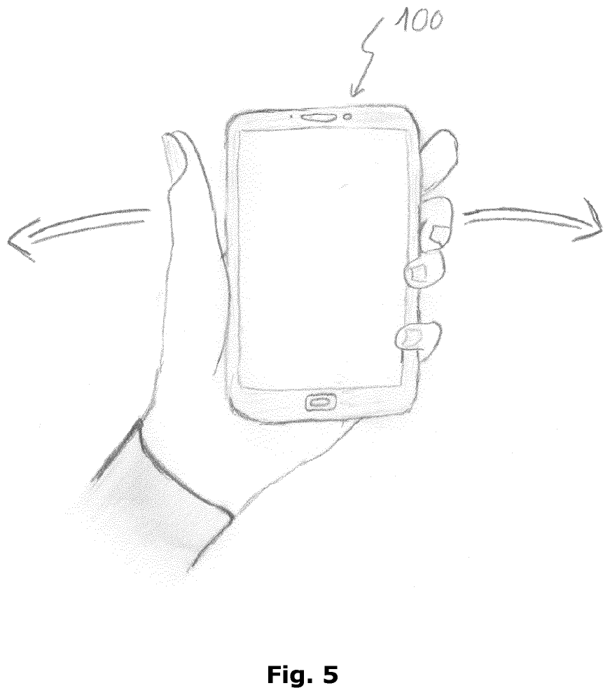

With reference to FIG. 5, the moving of a movable device 100 during step 320 is illustrated. A user may use a movable device 100, e.g. a smartphone, to monitor the detected images for a desired feature chosen by the user in step 310. The user may move the movable device 100 in any direction, such as left, right, up or down, where left and right are exemplarily indicated by the two arrows in FIG. 5. This may increase the chances of capturing an image containing the desired feature and/or may allow to capture multiple, potentially different pictures of a desired feature. For example, from different perspectives and/or in different settings or lightings. Thus, the moving of the movable device 100 may increase the chances of capturing an image of the desired feature that is visually pleasing for the user. In other words, moving the movable device may provide means to improve the probability to capture an image of a desired feature and further to provide an aesthetically pleasing image according to the user's perception.

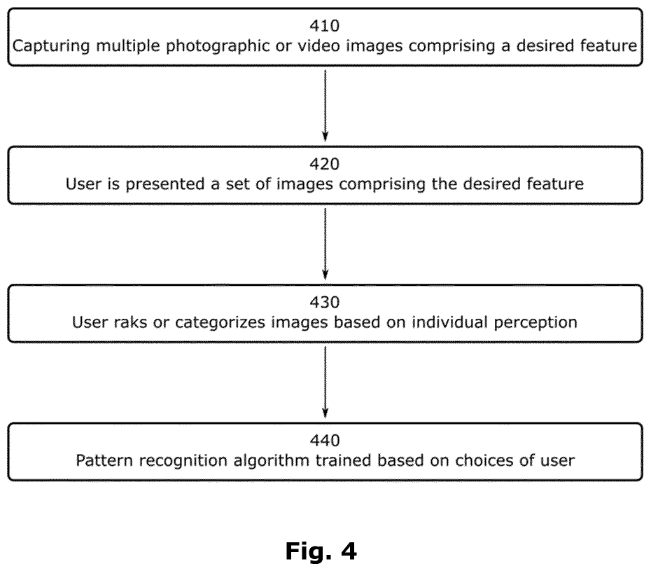

The image pattern recognition algorithm may further be trained by the user to improve the satisfaction of an individual user with the results, i.e. the images taken comprising a desired feature. The process of training the pattern recognition algorithm is illustrated in the flow chart in FIG. 4.

First, multiple photographic or video images comprising a desired feature are captured and stored (step 410). Subsequently, a selection of images comprising the desired feature is presented to the user (step 420), for example by showing them on the screen 140 of the movable device 100.

The user may than rank or categorize the images based on individual perception. That is the user may decide which images are particularly good or bad with respect to the desired feature and overall aesthetics (step 430). For example, the user may rank all pictures from best to worse, the user may assign a numerical value to every picture, e.g. a value in the range of 0 to 1, indicating the agreement with the expectation of the user, or the user may categorize the images in the categories: good, bad, neutral or undecided.

In a final step the obtained data are used to train the image pattern recognition algorithm (step 440). This may allow to obtain improved and individualized results for future uses.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. Method of automatically capturing a target image in a movable device (100) comprising the steps of:
a. providing at least one image feature for the target image to be captured;
b. monitoring image data;
c. capturing at least one target image when the image data monitored fulfills the image feature.

2. Method according to claim 1 wherein the monitoring of the image data is performed by a processing component (110) of the device, such as a GPU or CPU.

3. Method according to claim 1 wherein the movable device (100) is a portable or handheld device, such as a smartphone or tablet.

4. Method according to claim 1 wherein the image feature is provided by a feature library and the feature library is provided by the movable device.

5. Method according to claim 1 wherein the monitoring of the image data comprises a controlling by a controlling library and the controlling library is provided by the movable device.

6. Method according to claim 1 with the further step of uploading the image feature from a feature library into a cache or RAM storage of the movable device (100) before the monitoring of the images.

7. Method according to claim 1 with the step of moving with a moving speed of between 0.05 m/s to 50 m/s, preferably between 0.1 m/s to 30 m/s and more preferably between 0.1 m/s to 20 m/s.

8. Method according to claim 1 wherein the device or the drive is at least one of a semi-autonomous drive and autonomous drive, such as a drone or a robot.

9. Method according to claim 1 wherein the image data Is reduced in at least one of resolution and quality during its monitoring and wherein the ratio of at least one of the resolution and quality of the image data monitored and the one displayed is at least 1:2, preferably at least 1:3 and more preferably at least 1:5.

10. Method according to claim 1 wherein the images monitored are displayed in real time on a screen.

11. Method according to claim 1 wherein the machine learning algorithm is trained on the movable device (100) by the end user to recognize visually pleasing images according to guidelines set by an individual or a company.

12. Method according to claim 1 wherein the image pattern recognition algorithm comprises a machine learning algorithm to estimate an image transformation that enhances at least one of the colors, tonality and texture of the image to make the resulting image more aesthetically pleasing.

13. Method according to claim 12 wherein the machine learning algorithm to estimate an image transform that enhances at least one of the colors, tonality and texture of the image to make the resulting image more aesthetically pleasing is trained on pairs of images/videos that have been post processed by expert human image/video editors before.

14. Method according to claim 12 wherein the machine learning algorithm is provided to estimate an image transformation that enhances at least one of the colors, tonality and texture of the image to make the resulting image more aesthetically pleasing is trained by two independent sets of images/videos; a set of unprocessed images/videos and a second set of images/videos that have been manually post processed by an expert human image/video editor.

15. A computer program product comprising instructions, which, when the program is executed by a device (100), cause the device to perform a method of automatically capturing a target image in the movable device (100) comprising the steps of:
a. Providing at least one image feature for the target image to be captured;
b. Monitoring image data;
c. capturing at least one target image when the image data monitored fulfils the image feature.

16. A movable system (100) for automatically capturing a target image comprising:
a. a storage (130; 210) with at least one image feature for the target image to be captured;
b. a monitoring component (110) for monitoring image data;
c. a capturing component (120, 130) for capturing at least one target image when the image data monitored fulfills the image feature.

17. Method according to claim 1 with the step of moving the device by at least one of a user and a user-controlled drive and an automated drive.

18. Method according to claim 1 with the step of generating or optimizing the image feature by an image pattern recognition algorithm analysing selected images representative for the image feature on the device (100).
